(19) United States
(12) Patent Application Publication
(10) Pub. No.: US 2017/0063466 A1
(43) Pub. Date: Mar. 2, 2017

(54) OPTICAL TRANSMITTER AND METHOD FOR ADJUSTING SIGNAL LEVELS

(71) Applicant: Avago Technologies General IP (Singapore) Pte. Ltd., Singapore (SG)

(72) Inventors: Xiaozhong Wang, Cupertino, CA (US); David Chak Wang Hui, Santa Clara, CA (US)

(21) Appl. No.: 14/841,753

(22) Filed: Sep. 1, 2015

(51) Int. Cl. H04B 10/516; H04B 10/50; H04B 10/564; H04B 10/079

(52) U.S. Cl. CPC H04B 10/5161; H04B 10/07955; H04B 10/503; H04B 10/564

(57) ABSTRACT

An amplitude encoded transmission system and method are disclosed that achieve an improved bit-error rate for systems with a non-linear input/output relationship in the presence of noise. A set of measures are determined for adjacent signal levels. The set of measures are compared to each other. When at least one of the set of respective measures does not approximate the remaining measures in the set of measures, one or more signal levels are adjusted until the set of respective measures of the transmitter approximate each other. The method can be applied during a select manufacturing stage of the transmitter. An integrated system includes an optical emitter, modulator, photosensitive diode and signal-level adjuster. The modulator receives a set of control signals to operate the emitter at a desired output level. The photosensitive diode generates a feedback signal that is used by the signal-level adjuster to generate a bias signal.

### TECHNICAL FIELD

The present invention relates generally to amplitude modulated optical communication systems, and more particularly, to methods and apparatus for improving spectral efficiency in such amplitude modulated optical communication systems.

### BACKGROUND

The explosive growth of digital communications technology has resulted in an ever-increasing demand for bandwidth for communicating digital information, such as data, audio and/or video information. To keep pace with the increasing bandwidth demands, new or improved network components and technologies must constantly be developed to perform effectively at the ever-increasing data rates. In optical communication systems, however, the cost of deploying improved optical components becomes prohibitively expensive at such higher data rates. For example, it is estimated that the cost of deploying a 40 Gbps optical communication system would exceed the cost of existing 10 Gbps optical communication systems by a factor of ten. Meanwhile, the achievable throughput increases only by a factor of four.

Thus, much of the research in the area of optical communications has attempted to obtain higher throughput from existing optical technologies. A number of techniques have been proposed or suggested to increase spectral efficiency. Multi-level signaling, for example, has been used in many communication systems, such as 1000BASE-T Gigabit Ethernet, to increase spectral efficiency. The use of such multiple level transmission techniques in an optical system, however, would generally require more expensive optical components and linear lasers, in order to properly distinguish the various levels.

In one conventional implementation, a pulse-amplitude modulation (PAM) scheme with four transmission levels is used to communicate two bits during each bit period or unit interval (UI). A two-bit symbol is represented by one of the four discrete levels. As shown in FIG. 1, a PAM4 signaling scheme transmits twice as many bits over the same number of unit intervals as a two-level signaling scheme and a PAM8 signaling scheme transmits three times as many bits over the same number of unit intervals. In general, the discrete levels are equally spaced. When an output of a transmission system using such a scheme is repetitively sampled and applied to a vertical input of an oscilloscope and when the data rate is used to trigger the horizontal sweep of the oscilloscope, a multi-level “eye pattern” is formed. An “eye pattern” is the synchronized superposition of all possible representations of the signal of interest viewed within a particular signaling interval. An eye pattern looks like a series of eyes between a pair of rails.

Several system performance measures can be derived by analyzing the display. If the signals are too long, too short, poorly synchronized with the system clock, too high, too low, too noisy, or too slow to change, or have too much undershoot or overshoot, this can be observed from the eye diagram. An open eye pattern corresponds to minimal signal distortion. Distortion of the signal waveform due to inter-symbol interference and noise appears as closure of the eye pattern.

An example eye pattern for a conventional PAM4 signaling scheme is shown in FIG. 2A. As illustrated, the defined signal amplitudes representing the two-bit symbols 00, 01, 10, and 11 form three separate eye patterns. Eye patterns “Eye 0”, “Eye 1”, and “Eye 2” can be used to evaluate the combined effects of channel noise and intersymbol interference on the performance of a baseband pulse-transmission system. While the example PAM4 generated eyes in FIG. 2A are clearly defined, a more realistic representation of a PAM4 eye diagram showing how both a unit interval and the separation between adjacent eyes are influenced by overshoot, undershoot and noise is shown in FIG. 2B. Further degradation occurs when multi-level signals are transmitted over a link medium.

In the presence of noise, a given signal level in a multiple level signal transmission may cross an intended pre-defined level to cause an incorrect bit assignment in a receiver. U.S. Pat. No. 7,155,134 introduces a soft decision decoder that provides at least two soft slicing levels between each signal level to define an “uncertainty” region between adjacent signal levels. The soft decision decoder uses the soft slicing levels to evaluate the reliability of a given bit assignment. Thus, in addition to assigning a digital value (i.e., a hard output code) based on the received signal level, the disclosed soft decision decoder also generates a soft bit indicating a “reliability” measure of the output code. When the input signal is close to the defined signal level, the output code is very likely to be accurate and the soft bit is set to “1.” If, however, the input signal is in an “uncertainty” region, the output code is less reliable and the soft bit is set to “0.” If more than two slicing levels are used between two signal levels, it is possible to quantify the reliability with more than one bit. The reliability information provided by the soft decision decoder can be used by a forward error correction circuit to assign a corresponding digital value to the uncertain bit.

However, the above referenced solution does not address potential signal degradation in a multi-level transmission system that is introduced by a non-linear optical emitter. In addition, the above-referenced solution does not address potential signal degradation due to unpredictable noise introduced into the system by the optical emitter.

### BRIEF DESCRIPTION OF THE FIGURES

FIG. 1 illustrates the respective data capacities of three amplitude modulated signal transmission methods.

FIG. 2A illustrates a set of “eye” patterns created by a PAM4 signal transmission system.

FIG. 2B illustrates overshoot, undershoot and noise in a PAM 4 signal transmission system.

FIG. 3 illustrates a data plot of bias current and two operational parameters of an optical emitter.

FIG. 4A schematically illustrates a set of error distributions corresponding to each of the equally spaced signal amplitudes in a PAM4 signal transmission system.

FIG. 4B schematically illustrates a set of error distributions corresponding to signal amplitudes that have been modified.

FIG. 5 illustrates an embodiment of a transmitter that controllably adjusts signal power levels.

FIG. 6 illustrates an embodiment of the signal-level adjuster of FIG. 5.

FIG. 7 illustrates an embodiment of a method for adjusting signal levels in a transmitter defining M different signal levels.

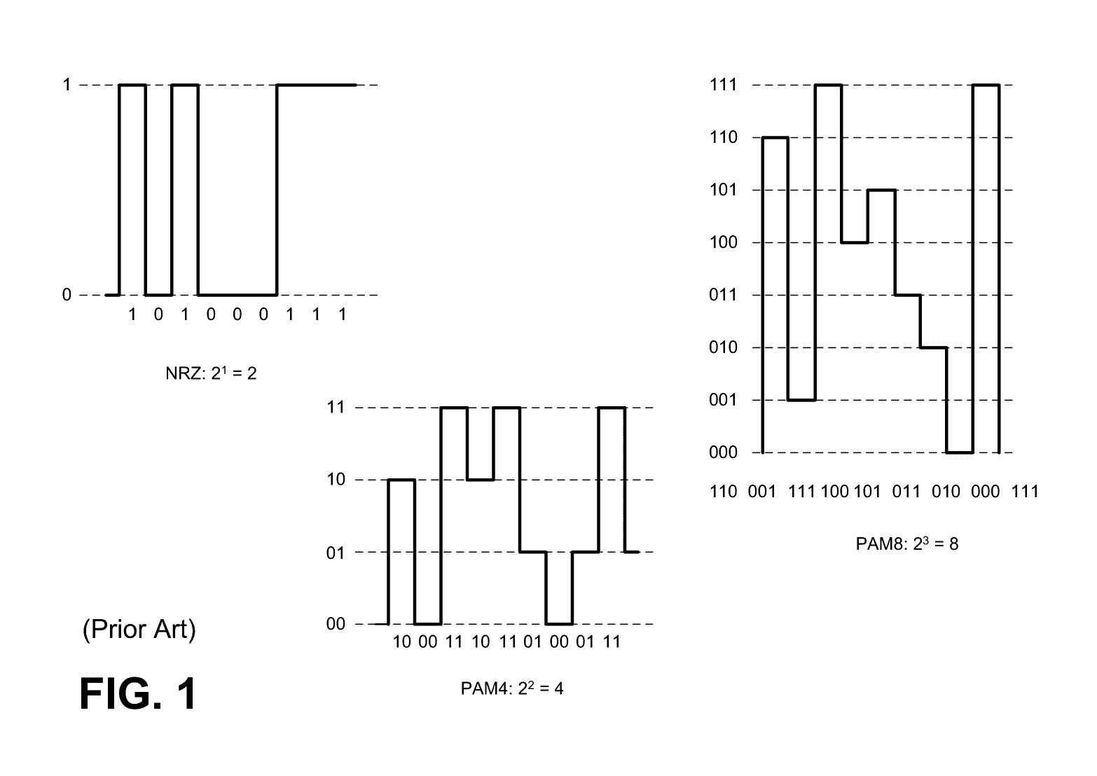

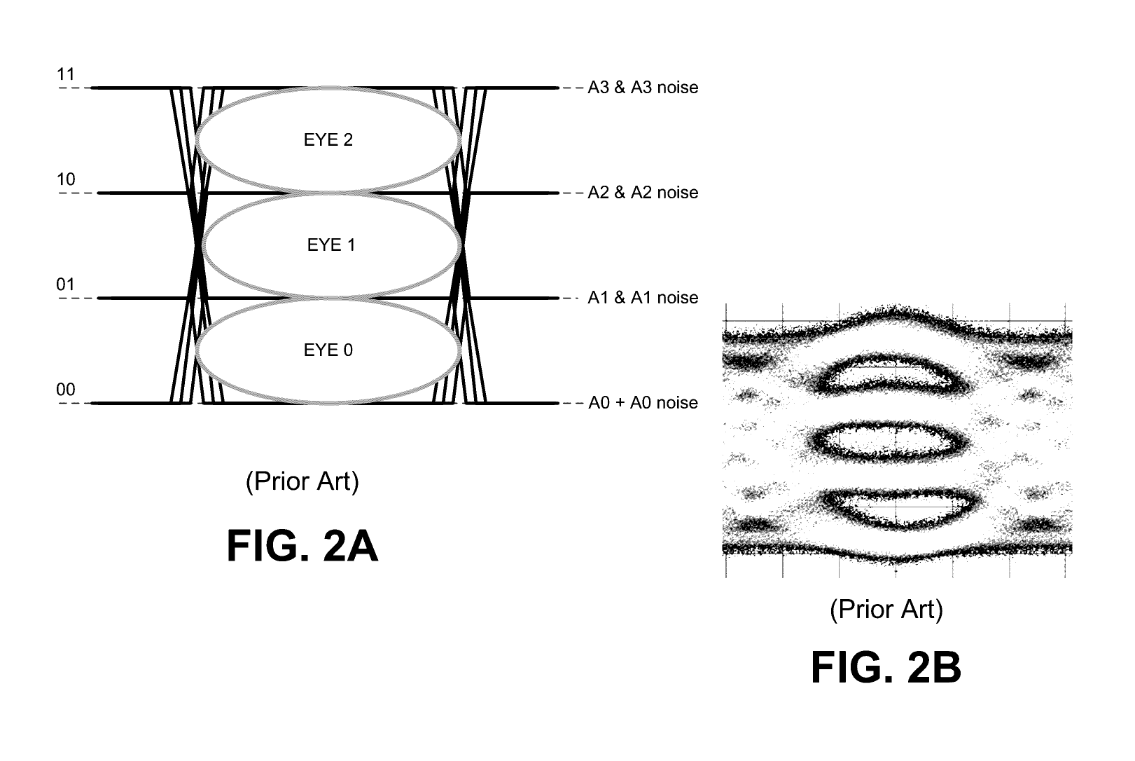

### WRITTEN DESCRIPTION

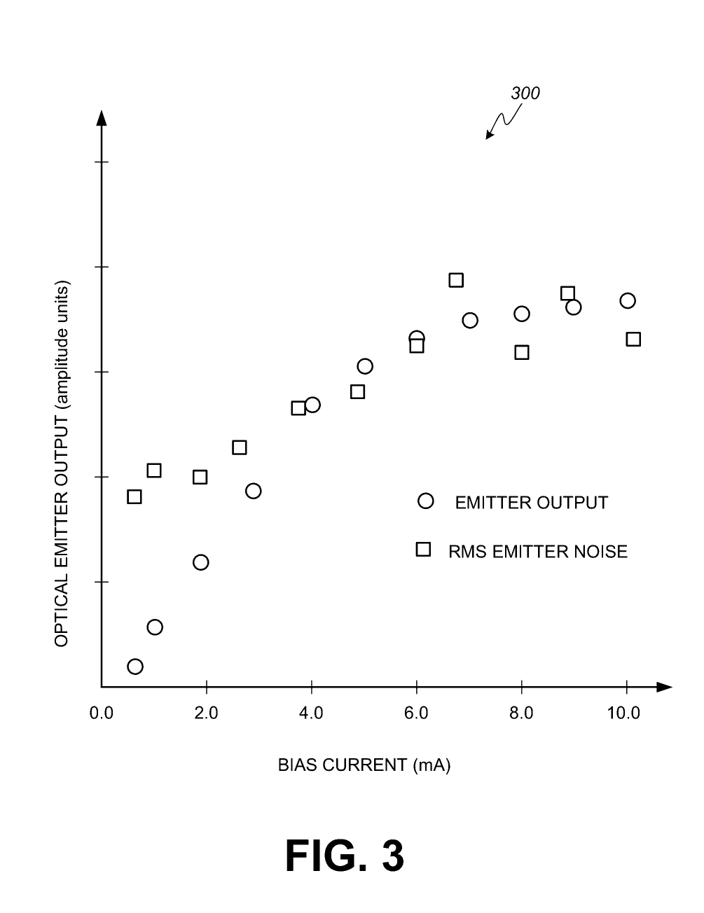

An amplitude encoded transmission system and method are disclosed that achieve an improved bit-error rate for systems with a non-linear input/output relationship in the presence of noise. FIG. 3 includes a data plot 300 illustrating emitter output and emitter noise over a range of bias current. The data plot 300 illustrates bias current in mA along the abscissa and optical emitter output (in amplitude units) along the ordinate. Emitter output amplitude may be represented or measured after conversion to an electrical signal in units of power, voltage, or current. When the emitter is an optical device, output amplitude may be further represented as a unit of luminous flux.

As illustrated in FIG. 3, data points depicted by a dot or circle reveal that for an example optical emitter the amplitude of output generated by the emitter is not linear over the entire range of operation. After about 6 milliampere (mA) of applied bias current, increases in the bias current or input of the optical emitter result in less of a change in the output amplitude. Similarly, data points represented by a square reveal that root-mean square of emitter noise is only somewhat linear over a portion of the range of operation. After about 6 mA of applied current, measured noise appears to be significantly more random.

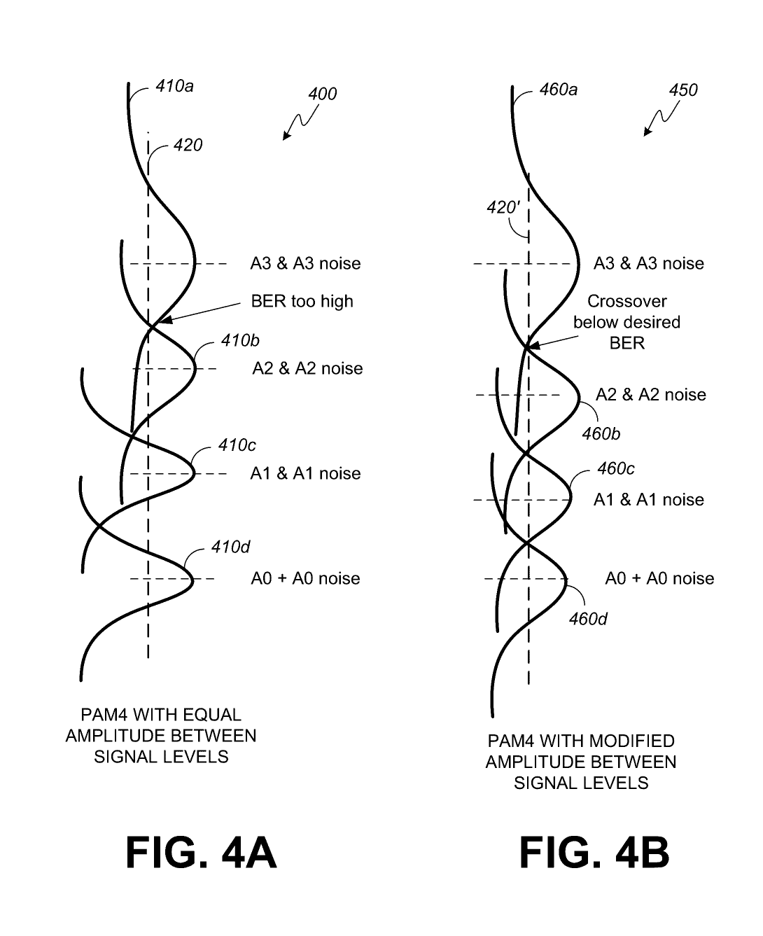

FIG. 4A schematically illustrates a set of error distributions 410a-410d corresponding to each of the equally spaced signal amplitudes in a PAM4 signal transmission system. A desired bit-error rate (BER) is represented by a vertical dashed line 420. Due to the combination of output amplitude linearity with respect to a controlled input and relatively lower noise levels corresponding to signal levels A0, A1 and A2, error distribution functions 410d, 410c and 410b indicate that potential errors in discerning whether signal level A0 or A1 is intended and whether potential errors in discerning whether signal level A1 or A2 is intended fall to the left of the desired BER 420 and are acceptable. However, the crossover point between error distribution function 410a and error distribution function 410b shows that the BER is higher than desired BER 420 and is too high when discerning whether signal level A3 or signal level A2 is intended.

FIG. 4B schematically illustrates a set of modified error distributions 460a-460d corresponding to signal amplitudes that have been modified. As illustrated in FIG. 4B, the amplitude between adjacent signal levels is no longer equal across the range of signal levels from A0 through A3. In the illustrated embodiment, both signal level A1 and signal level A2 have been lowered with respect to their respective levels as shown in the PAM4 signal transmission system illustrated in FIG. 4A. Consequently, the relative amplitude or spacing between signal level A3 and A2 is increased, the relative amplitude or spacing between signal levels A2 and A1 remains about the same, and the relative amplitude or spacing between signal levels A1 and A0 is decreased. As a result of the changes to two of the mid-range signal levels, the corresponding error distributions 460a through 460d each intersect an adjacent error distribution or error distributions to the left of the desired BER 420.

That is, the intersection between error distribution 410a and error distribution 410b between signal levels A3 and A2 in the transmission system with equally spaced signal levels exceeded the desired BER 420. In contrast, after the signal level adjustments, the intersection of the modified error distribution 460a and modified error distribution 460b intersect to the left of the desired BER 420.

In an embodiment, the improved BER is achieved as follows. A set of measures are determined for adjacent signal levels. The set of measures are compared to each other. When at least one of the set of respective measures does not approximate the remaining measures in the set of measures, one or more signal levels are adjusted until the set of respective measures of the transmitter approximate each other. The method can applied during a select manufacturing stage of the transmitter by recording measures of emitter noise and emitter amplitude for a corresponding control input. The recorded results can be applied to a function responsive to adjacent signal levels. When the results for M−1 adjacent signal levels do not match each other within a desired tolerance, one or more of the select signal levels are adjusted until the results of the function responsive to adjacent signal levels substantially match each other.

A method for communicating multiple bits in a time slot includes determining a set of respective measures corresponding to M different amplitudes capable of being generated by a transmitter and comparing the set of respective measures corresponding to the M different amplitudes capable of being generated by the transmitter to each other, wherein when at least one member of the set of respective measures corresponding to the M different amplitudes capable of being generated by the transmitter does not equal one remaining member of the set of respective measures corresponding to the M amplitudes capable of being generated by the transmitter, controllably adjusting an amplitude of a member of the set of M amplitudes, the amplitude defining a multiple-bit symbol. When such an adjustment is required, the comparing step and the adjusting step may be performed until it is determined that the set of respective measures is within a threshold value.

In an example embodiment, the set of respective measures include amplitude and noise for each of the M different amplitudes. In an embodiment, the amplitude of interest is a signal power and the noise is a random amplitude noise. These measures from each of the select amplitudes may be applied to a ratio where the numerator includes a difference of adjacent power levels and the denominator includes a sum of noise measures recorded at the respective adjacent power levels.

In an example embodiment, an adjustment is made by decreasing the amplitude of a select signal level. In an alternative embodiment, the amplitudes of two signal levels are reduced. When two amplitudes are reduced the amplitudes may be selected from mid-range amplitudes from the M different amplitudes.

The transmitter typically comprises an optical emitter, such as, for example, a semiconductor laser. In an example embodiment, the semiconductor laser is a vertical cavity surface emitting laser or an edge emitting laser.

In a transmitter programming or calibration stage, a full range of input control signals may be provided to a modulator or other device coupled to the optical emitter. For each of the discrete input control signals, an output power level and a root mean square noise are recorded. Once two different input control signals have been applied and the corresponding output power levels and noise measurements are recorded, the adjustment circuitry can calculate a signal-to-noise ratio for the eye defined by the adjacent input control signals. Thereafter, a next adjacent input control signal can be applied and the output power level and noise recorded. Upon completion of these measurements, a signal-to-noise ratio for the subsequent eye can be determined. The described data collection process can be repeated until the output signal power levels and noise measurements have been completed for the M−1 eyes.

Thereafter, a signal-to-noise ratio for one of the M−1 eyes may be compared to the remaining signal-to-noise ratios. A result of each of the comparisons may be further compared against a desired threshold. As described, when one or more respective signal-to-noise ratios does not match the remaining signal-to-noise ratios, adjustment circuitry generates a bias signal or bias signals to decrease one or more of the discrete power levels that are to be used by the transmitter. As will be described in association with exemplary embodiments, the bias signal or bias signals as the case may be are applied to a control input or inputs of a digital-to-analog converter, decoder, or an amplifier coupled to the optical emitter.

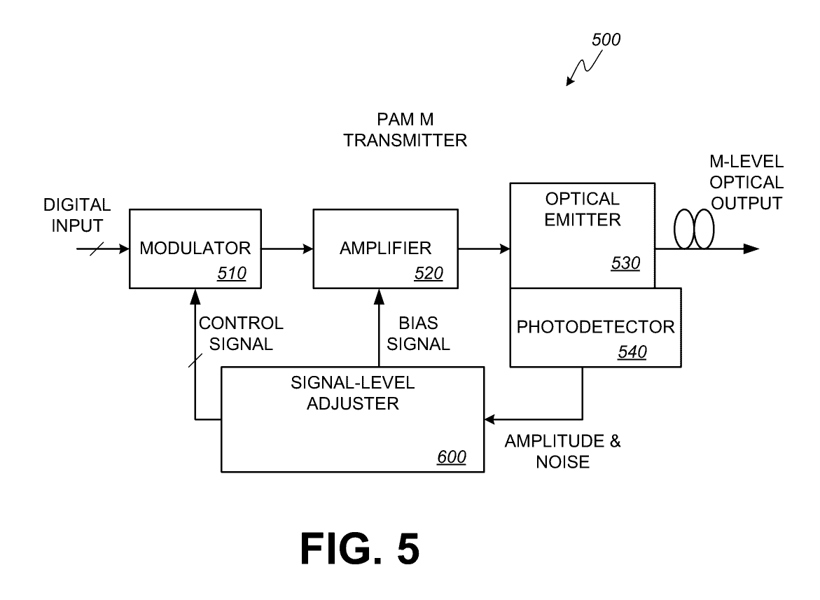

FIG. 5 illustrates an embodiment of a transmitter 500 that controllably adjusts signal power levels for a multiple-level communication system. The transmitter 500 receives a M-level encoded digital input signal and generates a M-level optical output signal that is optically coupled to a fiber or other light conveying medium for communicating the M-level encoded version of the digital input to a receiver (not shown) coupled to an opposed end of the fiber. The transmitter 500 receives a digital word or a portion of a digital word and in accordance with one or more clock signals (not shown) processes a subsequent digital word or portion of a digital word during a unit interval.

As shown, the transmitter 500 includes a modulator 510, an amplifier 520 and an optical emitter 530 that together form a transmit signal path. The modulator 510 receives the digital input signal at a modulator input and communicates an analog representation of the digital input signal at a modulator output. The amplifier 520 receives the analog representation of the digital input signal at a signal input and generates an amplified version of the analog representation at an amplifier output. The optical emitter 530 receives the amplified version of the analog representation of the digital input signal and converts the received signal into an optical signal which is coupled to the fiber for transmission to the receiver (not shown).

In example embodiments, the modulator 510 may be implemented by a digital-to-analog converter or DAC (not shown) that can convert a multiple-bit digital signal or symbol into a corresponding analog signal. In this arrangement, the DAC can generate a range of adjustments limited only by the dynamic range of the DAC. In other embodiments, an encoder (not shown) may be inserted in series with a DAC or multiple DACs to convert a digital input symbol to an amplifier input. A digital control word can be used to make adjustments in the encoder or DAC. A bias signal can be applied to further adjust the DAC. Alternatively, a bias signal may be applied to adjust the output of the amplifier 520.

There are alternative ways to enable repeatable control of multiple signal levels generated by the transmitter 500. For example, two non-return-to-zero (NRZ) signals can be combined to generate four separate signal levels. If one of the two NRZ signals is approximately twice the amplitude of the remaining NRZ signal, the lowest signal level and the highest signal level can be determined by the NRZ signal with the smaller of the two amplitude ranges and the mid-range signal can be determined by the difference of the two NRZ.

Preferably, the optical emitter 530 includes one or more instances of a semiconductor laser. Examples of suitable semiconductor lasers include a vertical cavity surface emitting laser or an edge emitting laser. While a single instance of an amplifier 520 is shown in the example embodiment, additional instances of amplifier 520 may be provided to control the amplitude of the optical signal generated by the optical emitter 530. Multiple instances of amplifier 520 may be arranged in configurations that use multiple semiconductor lasers to generate a multiple level optical output signal.

As further illustrated, the transmitter 500 also includes a feedback path. A photodetector 540, which may be, for example, a p-intrinsic-n (PIN) photodiode, is arranged to receive a portion of the optical signal generated by the optical emitter 530. The portion of the optical signal incident upon a light sensitive region of the photodetector 540 is converted to an analog feedback signal that includes a measure of the amplitude and noise present in the optical signal. The feedback signal is applied at an input of a signal-level adjuster 600, which is arranged to logically determine one or more appropriate signal level adjusts to apply in the signal path of the transmitter 500. As shown in FIG. 5, the signal-level adjuster 600 may produce a bias signal that can be applied at a control input of the amplifier 520. Alternatively, the signal-level adjuster 600 may produce a control word that is applied to a control input of the modulator 510 to adjust one or more predetermined signal levels defined in the modulator 510. In example embodiments, the signal-level adjuster 600 may generate one of the bias signal or the control signal. Alternatively, the signal-level adjuster 600 may generate and forward both the bias signal and the control signal. In still further embodiments, the signal-level adjuster 600 may generate and forward separate bias signals to one or more amplifiers and/or one or more DACs.

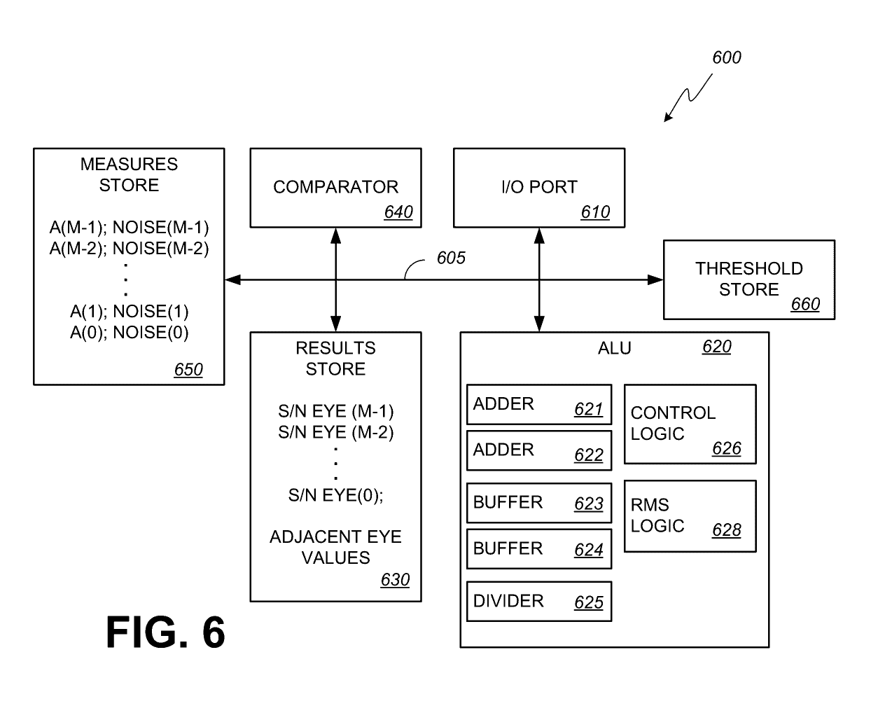

FIG. 6 illustrates an embodiment of the signal-level adjuster 600 of the transmitter 500 introduced in FIG. 5. In the illustrated embodiment, various functional elements are coupled to one another and to an input/output port 610 via a common communication bus 605. The input/output port 610 receives the feedback signal from the photodetector 540 and at appropriate times transmits one or both of the bias signal and the control signal. In addition, the input/output port 610 may receive a threshold value and configuration parameters that can be stored in the threshold store 660 or in other memory elements coupled to the communication bus 605 such as the measures store 650 or results store 630. For example, configuration parameters may include initial amplitudes for M different signal amplitudes. In general, these initial signal level values will include a base or lowest signal level and at the opposite end of the intended operational range, a greatest signal level. Any desired integer number of signal levels greater than two can be implemented by the signal level adjuster 600.

Arithmetic logic unit or ALU 620 includes adders 621, 622, buffers or registers 623, 624, divider 625, control logic 626 and root-mean square logic or RMS logic 628. As indicated in measures store 650, the signal-level adjuster retains an amplitude value which may be a measure of optical signal power or a signal voltage as provided by photodetector 540. A value is retained for each of the M signal levels. In alternative arrangements a current sensor could be added to provide a measured value response to the amplitude of the optical signal transmitted by the transmitter 500. In addition to the measured amplitudes of the optical signal, the RMS logic 628 is arranged to calculate a RMS noise or noise for each of the M signal levels, which may be stored in pairs with the accompanying amplitude value. The ALU 620 uses the adders 621, 622, buffers 623, 624, and divider 625 as directed by the control logic 626 to calculate a signal-to-noise ratio for each of the adjacent pairs of M signal levels. For example, in a PAM4 transmission system, the signal-level adjuster 600 will calculate a signal-to-noise ratio for each of the three eyes.

The signal-to-noise ratio is calculated by determining the difference in magnitude between the adjacent amplitudes divided by the sum of the RMS noise at each of the adjacent power levels. For the top eye, the signal to noise ratio is (A3−A2)/(noise3+noise2) when M=4. For the middle eye, the signal to noise ratio is (A2−A1)/(noise 2+noise1). For the lowest eye, the signal to noise ratio is (A1−A0)/(noise 1+noise0). The numerator can be calculated by adder 621 after a sign bit for the lower of the two amplitude levels is flipped. The numerator may be temporarily stored in buffer 623. The denominator can be calculated by adder 622 and a value temporarily stored in buffer 624. The divider 625 retrieves the numerator and denominator values from the buffer 623 and the buffer 624, respectively, and generates the signal-to-noise result. These signal-to-noise ratio results are stored in results store 630 and are used in an iterative analysis that compares the magnitude of the respective signal-to-noise ratio results. As indicated in FIG. 6 a comparator 640 is arranged on the communication bus 605 to perform the iterative analysis of the adjacent eye values in the results store 630. This iterative analysis of the relative similarity of the signal-to-noise ratios of the respective M−1 signal eyes may include the use of a threshold stored in threshold store 660.

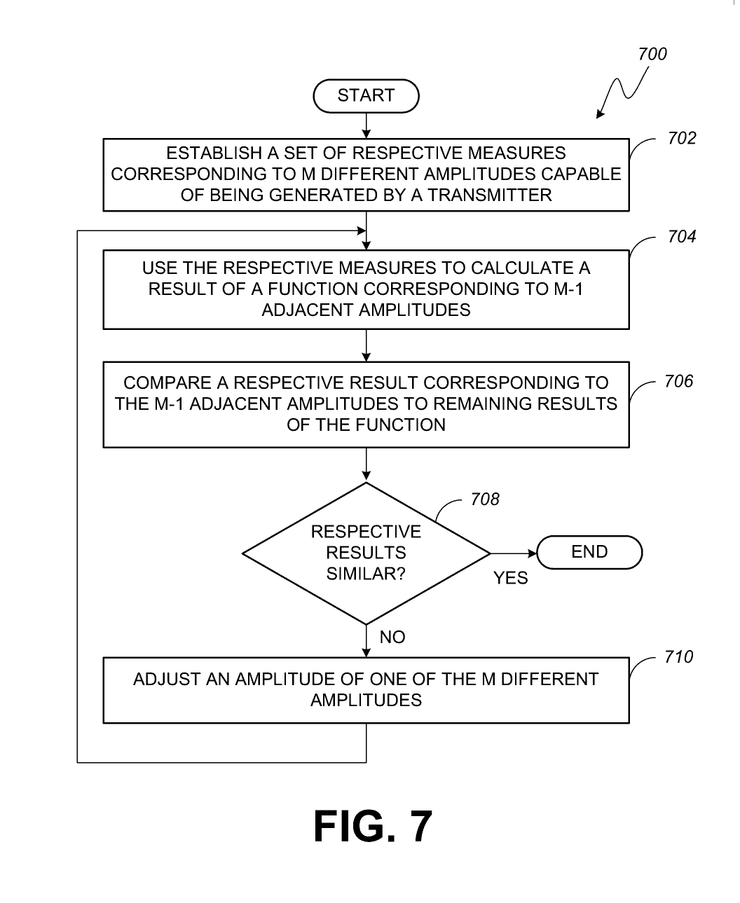

FIG. 7 illustrates an embodiment of a method 700 for adjusting signal levels in a transmitter defining M different signal levels. Method 700 begins with block 702 where a set of respective measures corresponding to M different signal amplitudes capable of being generated by the transmitter 500 are determined. The set of respective measures may be received and stored in a memory element within the transmitter 500 or within suitable storage elements in communication with the transmitter 500. Otherwise, the set of respective measures may be recorded and stored as a desired number of separate optical output signal levels are generated by controllably adjusting the input signal to the optical emitter 530 in a step-wise manner.

As described in association with the embodiment illustrated in FIG. 6, the respective set of measures include a measure of amplitude and noise for each of the separate signal levels. Preferably, each of the separate signal measures is characterized by an output power and root-mean square noise.

As indicated in block 704, the respective measures corresponding to the M different amplitudes are used to calculate a result of a function corresponding to the M−1 adjacent amplitudes. Thereafter, as illustrated in block 706, a comparison is made between a respective result corresponding to the M−1 adjacent amplitudes and the remaining results of the function.

In decision block 708, it is determined whether the respective results are similar. When the response is affirmative, the method 700 terminates. Otherwise, when the response is negative, method 700 continues with block 710 where the amplitude of one of the M different signal levels is adjusted. As shown by the flow control arrow exiting block 710, the calculation of the result of the function and comparison of the respective results to each other in block 704 and block 706, respectively, are repeated until the respective results are similar.

As described in association with the embodiment illustrated in FIG. 6, the set of respective results for the function corresponding to the M−1 adjacent amplitudes are compared by determining a difference value. As further described, the respective difference values may be compared with a threshold value. When the respective difference values each are at or below the threshold value, the respective results are considered similar enough to terminate the method 700.

It should be noted that the term “transmitter,” as that term is used herein, is intended to denote any type of optical communications module including an optical transmitter module that has optical transmitting capability, but not optical receiving capability, or an optical transceiver module that has both optical transmitting capability and optical receiving capability. It should also be noted that while the described embodiments include laser diodes and photodiodes for performing the electrical-to-optical conversion and optical-to-electrical conversion, respectively, any suitable light sources and light detectors, respectively, may be used for this purpose.

What is claimed is:

1. A method for communicating multiple bits in a time slot, comprising:
determining a set of respective measures corresponding to M different amplitudes capable of being generated by a transmitter, where M is an integer greater than two;
using the set of respective measures to calculate a result of a function of measures corresponding to M−1 adjacent amplitudes from the M different amplitudes;
comparing a respective result from the function of measures corresponding to the M−1 adjacent amplitudes to remaining results from the function;
adjusting an amplitude of a member of the set of M amplitudes, the amplitude defining a multiple-bit symbol, in response to the comparing.

2. The method of claim 1, further comprising:
repeating the comparing and adjusting until each member of the set of respective measures is within a threshold with respect to the remaining members of the set of respective measures.

3. The method of claim 1, wherein the respective measures include a function of signal power and noise.

4. The method of claim 3, wherein the function includes a ratio.

5. The method of claim 1, wherein controllably adjusting the amplitude includes decreasing an amplitude.

6. The method of claim 5, wherein controllably adjusting includes adjusting mid-range amplitudes.

7. The method of claim 1, wherein the transmitter includes a semiconductor laser.

8. The method of claim 7, wherein the semiconductor laser is one of an edge emitting laser or a vertical cavity surface emitting laser.

9. The method of claim 1, wherein the transmitter is responsive to a digital-to-analog converter.

10. The method of claim 1, wherein two non-return to zero signals are combined to generate a pulse amplitude modulated signal that forms three eyes.

11. A transmitter, comprising:
an optical emitter that generates an optical signal;
a modulator coupled to the optical emitter, the modulator configured to receive a set of control signals for operating the emitter in a M-level pulse-amplitude modulation mode of operation, where M is an integer greater than two;
a photodetector arranged to receive at least a portion of the optical signal and to generate a feedback signal including a representation of optical signal amplitude and noise; and
a signal-level adjuster arranged to receive the feedback signal and to generate a bias signal responsive to a comparison of a function of adjacent pulse amplitude modulation power levels and corresponding noise values measured at the adjacent pulse amplitude modulation power levels.

12. The transmitter of claim 11, wherein the bias signal is applied to a control input of a digital to analog converter.

13. The transmitter of claim 11, wherein the bias signal is applied to a control input of an amplifier.

14. The transmitter of claim 11, wherein the function includes a difference of semiconductor laser output power levels.

15. The transmitter of claim 11, wherein the function includes a sum of the corresponding noise values recorded at the adjacent pulse amplitude modulation power levels.

16. The transmitter of claim 11, wherein the signal-level adjuster modifies one of the M levels.

17. The transmitter of claim 11, wherein the signal-level adjuster modifies at least one of the M levels until a result of the function for any two adjacent levels is approximately equal to the function for remaining adjacent levels.

18. The transmitter of claim 11, wherein the modulator includes a digital to analog converter.

19. The transmitter of claim 11, wherein the modulator includes an encoder.

20. The transmitter of claim 11, wherein the optical emitter is one of an edge emitting laser or a vertical cavity surface emitting laser VCSEL.

21. A signal-level adjuster, comprising:
a port arranged to receive a feedback signal representing a present amplitude and noise of a transmit path output signal;
storage locations coupled to the port by a bus, the storage locations suitable for storing the present amplitude and noise of the transmit path output signal over unit intervals of an encoded transmit path output signal;
first logic arranged to determine a measure of the noise over the unit intervals; and
control logic coupled to the port and the storage locations by the bus, the control logic configured to generate at least one of a bias signal and a control signal responsive to a comparison of a function of adjacent pulse amplitude modulation power levels and the measure of the noise corresponding to adjacent pulse amplitude modulation power levels.
